(19) United States
(12) Patent Application Publication
(10) Pub. No.: US 2006/0218506 A1
(43) Pub. Date: Sep. 28, 2006

(54) Adaptive menu for a user interface

(76) Inventors: Edward Srenger, Schaumburg, IL (US); Daniel S. Rokusek, Long Grove, IL (US); Kevin L. Weirich, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/088,131

(22) Filed: Mar. 23, 2005

(51) Int. Cl. G06F 9/00

(52) U.S. Cl. 715/810

(57) ABSTRACT

A method and apparatus for adapting a help menu on a user interface, utilizing an input method such as a speech recognition system, for increased efficiency. A list of menu items is presented on the user interface including an optional menu item to reinstate any previously removed menu items. A user selects an item from the menu, such as a help menu, which can then be removed from the list of menu items in accordance with predetermined criteria. The criteria can include how many times the menu item has been accessed and when. In this way, help menu items that are familiar to a user are removed to provide an abbreviated help menu which is more efficient and less frustrating to a user, particularly in a busy and distracting environment such as a vehicle.

### FIELD OF THE INVENTION

This invention relates generally to user interfaces for electronic devices, and more particularly to menu usage on a user interface, such as is found in a communication device for example.

### BACKGROUND OF THE INVENTION

Electronic systems and their control software can be very complex and therefore benefit from the use of menus to access functions that are not readily known to a particular user. For example, all types of computer software commonly use pull down menus to access various functions. In addition, automatic telephone answering and forwarding systems typically use a multilayered menu approach. Similarly, wireless communication systems, such as portable or mobile cellular telephones for example, have become more complex leading to the incorporation of menus on a user interface to enable a user to access the many available functions.

In these cases, systems may have become complex enough wherein a user will be unaware of all the possible functions available. Therefore, help menus are often provided on a user interface. A problem arises in those situations where users may not be able to focus their time and attention on a menu system, such as when driving a vehicle, wherein using a fully functioned help menu would only serve to distract the driver and the driver may miss information. Similarly, telephone users forced to proceed through long interactive system menus can become frustrated.

Further problems arise when the user interface is relying on a speech recognition system to input commands, as opposed to a keyboard or other means. In today's speech recognition systems, a user when unsure about the list of commands available to navigate the various system menus will invoke the help command. The context sensitive help system will then provide the user with a long help message describing the various functions and commands active at that level in the user interface. The major drawback of this approach is that the user may have to listen to a lengthy help message before being able to proceed with his intended transaction. This can cause the user to become frustrated and impatient with the system, with the induced stress potentially resulting in lower recognition performance and increased task completion time.

One possible solution to the problem is to automatically shorten menus depending upon a user's most often used “favorite” commands. However, this solution is not well suited to the case of help menus where a user is specifically looking for information on available commands (i.e. commands they would not be familiar with). In other words, a user would not be searching a help menu for commands they are already well versed with.

What is needed is a user interface with a menu system that can be automatically adapted, based on usage pattern, to provide efficient assistance and an enhanced user experience. In addition, it would be of benefit to accommodate different users and track how the menu system is used to allow for a dynamic adjustment of the presented information depending on the usage profile of each system user.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a simplified block diagram for an apparatus, in accordance with the present invention;

FIG. 2 shows a simplified diagram of a main menu hierarchy;

FIG. 3 shows a simplified diagram of a full help menu;

FIG. 4 shows a simplified diagram of an adapted help menu, in accordance with the present invention; and

FIG. 5 shows a simplified block diagram of a method, in accordance with the present invention.

### DETAILED DESCRIPTION OF THE PREFERRED EMBODIMENT

The present invention provides an apparatus and method for adapting menus of a user interface in order to provide efficient assistance to meet a user's needs. Different users' habits can be accommodated and tracked to further assist users efficiently. Specifically, the present invention utilizes an adaptive help menu that capitalizes on the user's previous interaction pattern and experience with the system in order to provide a more fluid dialog with a voice activated system in a mobile environment.

The concept of the present invention can be advantageously used on any electronic device with a user interface that can interact with a user using visual, audio, voice, and text signals. In the example provided below, a wireless radio telephone is described using an audio and voice interface. Preferably, the radiotelephone portion of the communication device is a cellular radiotelephone adapted for mobile communication. However, the present invention is equally applicable to a pager, personal digital assistant, computer, cordless radiotelephone, portable cellular radiotelephone, or any other type of electronic or communication device that uses menus on a user interface. The radiotelephone portion in the example given generally includes an existing microphone, speaker, controller and memory that can be utilized in the implementation of the present invention. The electronics incorporated into a mobile cellular phone, are well known in the art, and can be incorporated into the communication device of the present invention. The user interface can include displays, keyboards, audio devices, video devices, and the like.

Many types of digital radio communication devices can use the present invention to advantage. By way of example only, the communication device is embodied in a mobile cellular phone, such as a Telematics unit, having a conventional cellular radiotelephone circuitry, as is known in the art, and will not be described in detail here for simplicity. The mobile telephone, includes conventional cellular phone hardware (also not represented for simplicity) such as processors and user interfaces that are integrated into the vehicle, and further includes memory, analog-to-digital converters and digital signal processors that can be utilized in the present invention. Each particular electronic device will offer opportunities for implementing this concept and the means selected for each application. It is envisioned that the present invention is best utilized in a vehicle with an automotive Telematics radio communication device, as is presented below, but it should be recognized that the present invention is equally applicable to home computers, portable communication devices, control devices, electronic devices, or other devices that have a user interface that utilize a menu system.

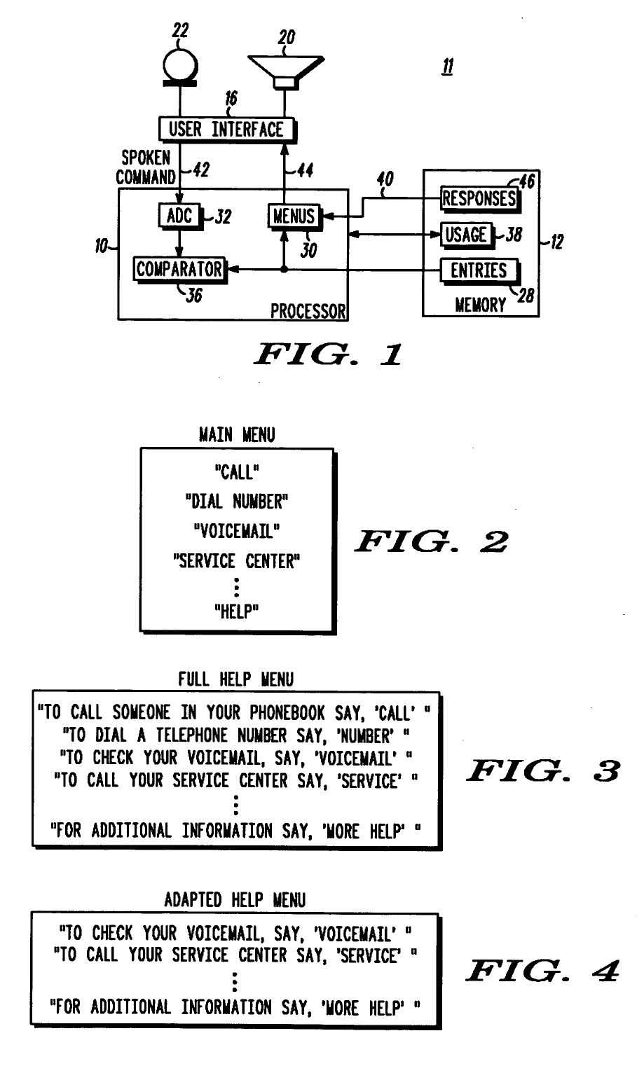

FIG. 1 shows a simplified representation of an electronic device 11, such as a communication device, having a user interface 16 that implements an adaptive menu, in accordance with the present invention. The communication device can be a Telematics device with a speech recognition system installed in a vehicle, for example. A processor 10 is coupled with a memory 12. The memory can be incorporated within the processor or can be a separate device as shown. The processor can include a microprocessor, digital signal processor, microcontroller, and the like, and can include a speech recognition system with its associated speech user interface. An existing user interface 16 of the vehicle can be coupled to an existing processor 10 and can include a microphone 22 and loudspeaker 20. Alternatively, a separate processor and user interface can be supplied.

The memory 12 typically contains pre-stored menu items or entries characterizing each system function that a user can control 28 and, where appropriate, possible responses enabling for further visual or audio 46 interactions with a user. In the case of a user interface with a display, these menu entries can be text or graphics. In the case of a speech recognition system as in the present example, the pre-stored menu entries will be a set of grammars or rules that control the user's range of options at any point within the speech recognition user interface. Instead of a user pressing a button for placing a call, the user can instead invoke this action through a vocal command such as “dial”. The system responses (46) in this case will be in the form of audio feedback such as “To dial a telephone number, say ‘Dial Number’” or “Dialing 555-1212” that can be played back 40 over the loudspeaker 20 to a user to either prompt the user for input or to provide feedback to a user's speech input. Of course, corresponding visual or text menu responses can be easily substituted on the available user interface. The processor automatically creates a list of menu items 30 from the information in the memory 12, as will be described below.

Upon startup of the electronic device, the processor 10 is operable to create a list of menu items 30 from the memory 12. The user interface 16 is operable to output the list of menu items 30 and input menu selection information 42 from a user. A user can enter or speak a command, such as “Menu”, “Help”, or the like into the user interface 16 (e.g. microphone 22) of the electronic device 11. The microphone transduces the audio signal into an electrical signal. The user interface passes this signal 42 to the processor 10, and particularly an analog-to-digital converter 32, which converts the audio signal to a digital signal that can be used by the processor 10. Further processing can be done on the signal by (digital signal) processing to provide a data representation of the user interface entry, such as a data representation for use in a speech recognition system for example. A comparator 36 compares the data entry to the representations of the list of possible menu entries 28, which are associated to the allowable actions that are active under a given menu, and takes further action thereon.

Referring to FIG. 2, upon startup of the electronic device, a user can be presented, or have access to, a menu through the user interface. The menu can be presented as text or on a display or can be accessed through a speech recognition system. For example, the menu can list commands such as “Call”, “Dial”, “Voicemail”, “Service Center”, and “Help”, among others. Any of the system menus and submenus can be subject to adaptation in accordance with the present invention. In a preferred embodiment, the present invention is applicable to any of the Help menus and submenus that are active in the system, as shown in FIGS. 3 and 4.

When a user begins to use a newly acquired electronic device, they will probably require some help in operating the device. Therefore, the full range of commands available for a given menu in the user interface will be provided in the corresponding menu, such as is shown in the Help menu of FIG. 3. The items listed in the menu can be any number of items that are used to properly operate the electronic device. In this example of a Help menu, the list of items can include audio prompts such as “To call someone in your phonebook list, say ‘Call’”, “To dial a telephone number, say ‘Dial Number’”, “To check your voicemail, say ‘Voicemail’”, “To reach your service center, say ‘Service’”, “For additional information, say ‘More Help’”, and the like. Unfortunately, for speech recognition systems or any type of audio response system, the presentation of an entire menu can be long and arduous. In distracting situations such as a vehicle environment, listening to a long help menu would be frustrating, and may cause the user to miss information.

FIG. 4 shows an adaptive menu, such as a help menu, wherein a user's proficiency in using system commands would cause the help menu to be adapted by dropping those commands that the user is the most familiar with. In this way, future use of the Help menu would provide a shortened menu having only those commands that the user is not well versed with using. In this example, a user may have commonly used the “Dial Number” and “Call” commands, so these commands can be dropped from the Help menu as shown.

To accomplish this, and referring back to FIG. 1, the present invention monitors the usage pattern 38 of a user to establish their familiarity with the system. Upon selection of a displayed or already known menu item by a user on the user interface the processor can remove the selected item from the list of menu items in accordance with predetermined criteria, as will be described below. For example, when the user successfully completes a task, with or without the assistance of the help menu, a counter is updated to record the menu item or used speech command and a timestamp in the usage profile 38 of the memory 12. For example, if a user successfully dials a telephone number by using the Dial Number command a counter is incremented in the usage profile 38 for that particular command along with the timestamp of when the command was successfully implemented. The adaptive menu system of the present invention can be set up to accommodate several users. Based on either speaker authentication or a user selecting a profile, the system can tailor the user experience for each user based on their interaction pattern and /or statistics stored in the usage profile 38.

Afterwards, the next time the help menu is invoked, the corresponding menu and command statistics are examined from the usage profile 38 of that user from memory. The list of commands 28 associated with the help menu is checked against a predetermined limit to determine the number of times each command was successfully used and if the command was used during a predetermined time period. The most commonly used commands, for the specific menu, are removed from the help message (as demonstrated in FIG. 4) leaving only those commands that a user is unfamiliar with. Usage can be compared against one or both of the predetermined limit and predetermined time period. For example, it may be determined that if a user has successfully used a command three times, then that user is proficient with that command and it can be dropped from the help menu. However, if a user has not used a command within a predetermined time period, such as one week, wherein if a user does not use a command the user may have forgotten how to use the command, wherein the command is reinstated to the list of menu items. Therefore, if it is determined from the usage profile 38 that a user has invoked the “Dial Number” command three times successfully within the past day, either one or both of these conditions would be sufficient to determine that the “Dial Number” command be removed from the help menu.

Of course, a user should always be able to obtain information about any command in a menu. Therefore, in the present invention the processor can create an optional menu, which when selected will reinstate any previously removed menu items from the help message. The optional menu item can be provided at the end of the list of menu items (of an adaptively abbreviated menu). In this way, the user is provided with the option to be presented with any removed commands should they need more information. For example, a “More Help” entry can be provided (see FIG. 4), wherein a user asking for “More Help” will be provided with the additional menu items not initially listed (see FIG. 3). Also, when a user invokes the extended help command, the statistics in the usage profile 38 associated with the command that they use to perform a task immediately after exiting the help menu is reset and the menu item is again included in the help message.

Optionally, an added response 46 such as a user tip or advice can be provided in the menu if repeated failures are detected for completing an action associated with a particular menu item. In other words, if a particular user has selected the same command from the list of menu items a predetermined number of times and unsuccessfully completed that action then the processor can provide further assistance to the user on the user interface. For example, if a user is having problems in the “Dial Number” command stringing together a series of continuous digits in speech recognition mode, the system could ask if user would like advice. The advice could be to “Speak continuously without pausing or articulate in a normal voice.” Advice could be offered based upon collected success statistics in the usage profile 38.

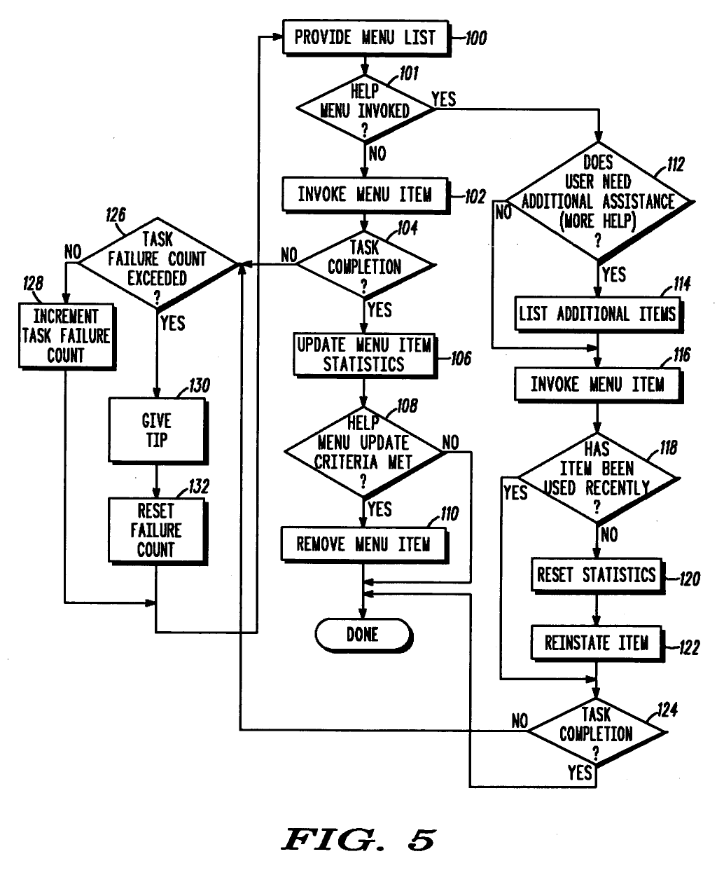

Referring to FIG. 5, the present invention also includes a method for adapting a menu, such as a help menu as is used in this example, on a user interface for increased efficiency. The method includes a first step 100 of providing a list of menu items, or commands, available in the user interface to the user. In this example, the user can be presented, or have access to, menu items via speech commands. The user can invoke 101 the help menu or just use menu commands already learned 102. The set of items presented in the help menu can be a complete command listing or a list already adapted into abbreviated form through previous use of the method, as will be detailed below.

In the case of a regular (non-help) menu item, a next step 102 includes using an item from the menu by the user. This can include a user actually selecting the item from a menu, or just invoking the menu item through a voice command without referring to the menu. It is then determined if the task associated with the menu item was successfully accomplished 104. The method keeps track of how many unsuccessful attempts are made. If a user has not completed the task (e.g. successfully used the “Dial Number” command by placing a call) then it is assumed that the user has not learned the menu item. Therefore, unless the task is actually accomplished, this particular event will not be counted towards removal of that particular item from the help menu. For example, if a particular user has unsuccessfully used the same menu item with a voice command from the list of menu items more than a predetermined number of times 126 then the method includes a further step 130 of providing further assistance to the user on the user interface, whereupon the failure count is reset 132 giving the user another predetermined number of times to successfully accomplish a selected task. Otherwise, a task failure counter is incremented 128 and the process returns to the beginning, waiting for the next user input.

Returning to step 104, in the case of a regular (non-help) menu item, if a task is successfully completed, indicating a user's proficiency in invoking such menu item. This is noted by updating menu item statistics 106 for that particular user. The statistics include keeping a statistical usage profile of menu item utilization for particular users. The profile can include a count of how many times the user has successfully used the menu command and completed the intended task, and when the command was used. This statistical usage profile is accessed as part of the criteria 108 in deciding when to remove an item 110. This step 106 can also include the substep of recording a timestamp of when a menu item was removed from a menu.

If the help menu has not been invoked 108 to assist the user with the particular menu item selected, then it is clear that the user is becoming proficient in using the selected command and this menu item can be removed from 110 from the list after a certain number of successful uses 108. The criteria can include counting how many times the user has used the menu item from the list of menu items wherein if the user has successfully used the menu item a predetermined number of times then that selected item can be removed from the list of items in the corresponding help menu next time this menu is invoked. The criteria can also include counting how many times the user has used the menu item from the list of menu items wherein if the user has used the menu item within a predefined time period then that selected item can be removed from the list of items in the help menu. Either or both of these criteria can be used in deciding whether to remove a menu item from the menu.

Once an item has been removed, the providing step 100 can include providing an optional menu item to reinstate any previously removed menu items for presentation to the user. In this way a user may obtain help on using a menu item that they may have forgotten. Further steps can determine when a menu item was removed, wherein the removed item can be reinstated to the list of menu items if the removed menu item has not been used within a predetermined period of time. For example, in regards to a user invoking the help menu 101, it can be determined 112 whether a particular user has selected to optionally reinstate removed menu items in the provided menu list by having the user invoking an additional command, such as “More Help”. If the user asks for such additional assistance, the user will obtain 114 the additional listing of items that had been previously removed.

If an item has not been used recently 118 it can be assumed that a particular user may have become unfamiliar with the use of the menu item and that this item should be reinstated so that the user will not miss help information on this menu item if needed. Therefore, if a menu item has not been used recently 118 the timestamp in the usage statistics can be reset 120 for the menu item for this particular user and the menu item can be reinstated 122 to the help menu list. Thereafter, the menu task completion test can be acted upon 124. If the task is completed successfully then no further action is taken in terms of updating specific statistics as the user has just used the command based on information provided in the help menu and is therefore not familiar yet with this command. If the task is not completed successfully then this will also be counted in the task failure count 126 as explained previously.

Advantageously, the present invention results in improved user experience as it can track the familiarity of a user with a menu-driven speech recognition system over time. The main benefits are lowered user frustration and faster task completion rates, which are essential for eyes-busy, hands-busy environments such as when driving a vehicle. In this way, a driver's cognitive load is applied to the main task (i.e. driving a vehicle) and not on using a voice activated command system. The present invention can best be used for in-vehicle hands-free automatic speech recognition (ASR) systems or hand-held device based ASR.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method for adapting a menu on a user interface for increased efficiency, the method comprising the steps of:
providing a list of menu items on the user interface to the user;
using an item from the menu by the user; and
removing the selected item from the list of menu items in accordance with predetermined criteria.

2. The method of claim 1, wherein the providing step includes providing an optional menu item to reinstate any previously removed menu items for presentation to the user.

3. The method of claim 1, wherein the criteria of the removing step includes counting how many times the user has successfully used the menu item from the list of menu items wherein if the user has used the menu item a predetermined number of times then that selected item is removed from the list of menu items.

4. The method of claim 1, wherein the criteria of the removing step includes counting how many times the user has used the menu item from the list of menu items wherein if the user has used the menu item within a predefined time period then that selected item is removed from the list of menu items.

5. The method of claim 1, further comprising the steps of:
recording a time when a menu item was removed, and
reinstating the removed menu item to the list of menu items if the removed menu item has not been used within a predetermined period of time.

6. The method of claim 1, further comprising the step of keeping a statistic profile on menu item utilization for particular users.

7. The method of claim 1, further comprising the step of keeping a statistic profile on menu item utilization for particular users, wherein if a particular user has unsuccessfully used the same menu item from the list of menu items a predetermined number of times then further comprising the step of providing further assistance to the user on the user interface.

8. The method of claim 1, wherein the providing step includes providing an optional menu item to reinstate any removed menu items for presentation to the user, and further comprising the step of keeping a statistical profile on menu item utilization for particular users, wherein if a particular user has selected to optionally reinstate removed menu items in the providing step then further comprising the step resetting the statistical profile for that user.

9. The method of claim 1, wherein the menu is a help menu and the user interface is a speech recognition system.

10. The method of claim 1, wherein the criteria of the removing step includes determining whether the user has successfully completed the task associated with the menu item.

11. A method for adapting a help menu on an audio user interface for increased efficiency, the method comprising the steps of:
providing a list of help menu items on the user interface including an optional help menu item to reinstate any previously removed help menu items;
using an item from the menu by the user;
completing the task associated with the menu item;
removing the menu item from the list of help menu items in accordance with predetermined criteria; and
keeping a statistical profile on menu item utilization for particular users.

12. The method of claim 11, wherein the criteria of the removing step includes one or more of the group consisting of counting if the user has used the menu item a predetermined number of times and determining if the user has used the menu item within a predefined time period.

13. The method of claim 11, wherein if a particular user has selected the same item from the list of menu items a predetermined number of times, without successful task completion, then further comprising the step of providing further assistance to the user on the user interface.

14. The method of claim 11, wherein if a particular user has selected to optionally reinstate removed menu items in the providing step then further comprising the step resetting the statistical profile for that user.

15. The method of claim 11, wherein the user interface is a speech recognition system in a vehicle.

16. A communication device with an adaptive menu for a user interface, the communication device comprising:
a memory that contains menu items;
a processor coupled to the memory, the processor operable to create a list of menu items from the memory including an optional menu item to reinstate any previously removed menu items; and
a user interface coupled to the processor, the user interface operable to output the list of menu items and input menu selection information from a user,
wherein upon use of a menu item by a user on the user interface the processor can remove the selected item from the list of menu items in accordance with predetermined criteria.

17. The device of claim 16, wherein the memory contains a counter for each menu item that counts the number of times that menu item has been used and a timestamp indicating when that menu item was used, wherein the criteria for removal includes one or more of the group consisting of counting if the user has used the menu item a predetermined number of times and determining if the user has used the menu item within a predefined time period.

18. The device of claim 16, wherein if a particular user has selected the same item from the list of menu items a predetermined number of times, without successful task completion, then the processor provides further assistance on this item to the user on the user interface.

19. The device of claim 16, wherein the processor stores a statistical profile on menu item utilization for particular users in the memory, wherein if a particular user has selected to optionally reinstate removed menu items the processor will then reset the statistical profile for the menu item of that user.

20. The device of claim 16, wherein the processor records in the memory a time when an item was removed, and reinstates the item to the list of menu items if the selected item has not been used within a predetermined period of time.
